(19) United States
(12) Patent Application Publication
(10) Pub. No.: US 2016/0110155 A1
(43) Pub. Date: Apr. 21, 2016

(54) COMMUNICATION TERMINAL, HOME NETWORK SYSTEM, AND CONTROL METHOD THEREOF

(71) Applicant: SAMSUNG ELECTRONICS CO., LTD., Gyeonggi-do (KR)

(72) Inventors: Liashchenko IEVGEN, Suwon-si, Gyeonggi-do (KR); Polyulya YURIY, Suwon-si, Gyeonggi-do (KR); Aleksandrov DMYTRO, Suwon-si, Gyeonggi-do (KR)

(73) Assignee: SAMSUNG ELECTRONICS CO., LTD., Suwon-si Gyeonggi-do (KR)

(21) Appl. No.: 14/893,357

(22) PCT Filed: May 22, 2014
(86) PCT No.: PCT/KR2014/004559

§ 371 Date: Nov. 23, 2015

(30) Foreign Application Priority Data
May 22, 2013 (KR) 10-2013-0057997

(51) Int. Cl. G06F 3/16; H04R 29/00; G05B 15/02; H04L 12/28

(52) U.S. Cl. CPC G06F 3/165; H04L 12/2803; H04R 29/00; G05B 15/02; H04R 2430/01

(57) ABSTRACT

A communication terminal, a home network system and a control method therefor are provided. In the control method of a communication terminal, if a call request is received from another communication terminal, a sound level of audio outputted by an external electronic device is detected. If the sound level of audio outputted by the electronic device is greater than or equal to a predetermined threshold value, a control command to reduce the sound level of audio outputted by the electronic device to the predetermined threshold value is transmitted to the electronic device. As a result, a user can make a call in a quieter environment without a separate operation.

### CROSS-REFERENCE TO RELATED APPLICATIONS

This application is the national stage of PCT Application No. PCT/KR2014/004559, filed May 22, 2014, designating the United States, which claims priority from Korean Patent Application No. 10-2013-0057997, filed May 22, 2013, in the Korean Intellectual Property Office. The contents of each of these applications are incorporated herein by reference in their entirety.

### BACKGROUND

1. Field

Apparatuses and methods consistent with the present disclosure relate to a communication terminal, a home network system, and a control method thereof, and more particularly, to a communication terminal, a home network system, and a control method thereof capable of controlling electronic devices in the home network system.

2. Description of Related Art

Recently, with development of communication technology, a home network system capable of controlling electronic devices and determining information of the electronic devices in the home indoors and outdoors by using mobile phones and computers has been implemented. Users may control security, temperatures, and lighting in the home anytime and anywhere by using the home network system.

In the case of making a call (for example, a voice call and a video call) in the home, large noise can be generated from the electronic devices and, thus, the users may be hindered in the call. For example, when a sound level outputted from a digital TV is too large or a vacuum cleaner operates while making the call, the user may not smoothly make the call due to large noise.

In order to remove noise generated from electronic devices in the home, in the related art, there is inconvenience in that the user needs to control the sound level and the power of the electronic devices one by one.

Particularly, when a remote controller for adjusting the sound level of the digital TV is not found or the remote controller or the cleaner is far away, there is a problem in that the user must stop the call and find the remote controller to control the sound level or the power.

### SUMMARY

Example embodiments of the present disclosure can overcome the above disadvantages and other disadvantages not described above. However, the present disclosure is not required to overcome the disadvantages described above, and an example embodiment of the present disclosure may not overcome any of the problems or disadvantages described above.

The present disclosure provides a communication terminal, a home network system, and a control method thereof having advantages of automatically removing noise generated when making a call, by transmitting to an external electronic device a control command to reduce a sound level of the external electronic device in the case in which the communication terminal making the call detects noise which is greater than or equal to a predetermined threshold value.

According to an aspect of the present disclosure, a control method of a communication terminal includes: detecting a sound level of audio outputted by an external electronic device when a call request is received from another communication terminal; and transmitting a control command to the electronic device to reduce the sound level of audio outputted by the electronic device to a predetermined value when the sound level outputted by the electronic device is greater than or equal to a predetermined threshold value.

The control method may further include determining a kind of electronic device outputting the sound level which is greater than or equal to the predetermined threshold value, when the sound level outputted by the electronic device is greater than or equal to the predetermined threshold value; establishing communication with the determined electronic device; and transmitting the control command to the determined electronic device when the communication with the determined electronic device is established.

In the determining, the kind of electronic device may be determined by using at least one of an output direction of the sound outputted from the electronic device, a frequency pattern of the sound, and a kind of sound.

In the transmitting, the control command may be transmitted to multiple external electronic devices with which the communication with the communication terminal is established when the sound level outputted by the multiple electronic devices is greater than or equal to the predetermined threshold value.

The detecting may include activating a sound level meter for detecting the sound level outputted from the electronic device when the call request is received from the other communication terminal.

The control method may further include, when the call with the other communication terminal ends, transmitting to the electronic device a control command for returning the electronic device to the sound level outputted before the call.

The predetermined threshold value and the predetermined value included in the control command may be user-configurable.

The external electronic device may include one or more of a digital television (TV), an audio device, a personal computer (PC), an air conditioner, and a cleaner.

When the external electronic device is a cleaner, a control command to turn off power of the cleaner may be transmitted to the cleaner.

According to another aspect of the present disclosure, a communication terminal includes: a first communicator configured to receive a call request from another communication terminal; a second communicator configured to perform communication with an external electronic device; a sound level detector configured to detect a sound level of audio outputted by the external electronic device; and a controller configured to control the second communicator to transmit to the electronic device a control command to reduce the sound level of audio outputted by the electronic device to a predetermined value when the sound level outputted by the electronic device detected through the sound level detector is greater than or equal to a predetermined threshold value.

The controller may determine a kind of electronic device outputting the sound level which is greater than or equal to the predetermined threshold value when the sound level outputted by the electronic device detected through the sound level detector is greater than or equal to the predetermined threshold value, control the second communicator to establish communication with the determined electronic device, and control the second communicator to transmit the control command to the determined electronic device when the communication with the determined electronic device is established.

The controller may determine the kind of electronic device by using at least one of an output direction of the sound outputted from the electronic device, a frequency pattern of the sound, and a kind of sound.

The controller may control the second communicator to transmit the control command to multiple external electronic devices with which communication with the communication terminal is established when the sound level outputted by the multiple electronic devices is greater than or equal to the predetermined threshold value.

The sound level detector may be activated only when the call request is received from the other communication terminal.

The controller may control the second communicator, when the call with the other communication terminal ends, to transmit a control command to the electronic device to return the electronic device to the sound level output before the call.

The predetermined threshold value and the predetermined value included in the control command may be user-configurable.

The external electronic device may include one or more of a digital television (TV), an audio device, a personal computer (PC), an air conditioner, and a cleaner.

When the external electronic device is a cleaner, the controller may control the second communicator to transmit a control command to the cleaner to turn off power of the cleaner.

According to another aspect of the present disclosure, a control method of a home network system including a communication terminal and an electronic device includes: detecting a sound level of audio outputted by the electronic device using the communication terminal when the communication terminal receives a call request from another communication terminal; transmitting a control command to the electronic device to reduce the sound level of audio outputted by the electronic device to a predetermined value using the communication terminal when the sound level outputted by the electronic device is greater than or equal to a predetermined threshold value; and reducing the sound level to a predetermined value based on the control command.

According to the diverse example embodiments of the present disclosure, the user may make a call in a quieter environment without a separate operation by automatically removing noise of the electronic device which may be generated when the communication terminal makes a call.

Additional and/or other aspects and advantages of the disclosed example embodiments will be set forth in part in the description which follows and, in part, will be apparent from the description, or may be learned by practice of the systems and methods described herein.

### BRIEF DESCRIPTION OF THE DRAWINGS

The above and/or other aspects of the present disclosure will be more apparent by describing certain example embodiments of the present disclosure with reference to the accompanying drawings, in which:

FIG. 1 is a diagram illustrating a home network system according to an example embodiment of the present disclosure;

FIG. 2 is a block diagram illustrating a configuration of a communication terminal according to the example embodiment of the present disclosure;

FIG. 3 is a block diagram illustrating a configuration of an electronic device according to the example embodiment of the present disclosure;

FIG. 4 is a flowchart for describing a control method of the communication terminal according to the example embodiment of the present disclosure; and

FIG. 5 is a sequence diagram for describing a control method of the electronic device in the home network system according to the example embodiment of the present disclosure.

### DETAILED DESCRIPTION OF THE EXAMPLE EMBODIMENTS

Hereinafter, various example embodiments of the present disclosure will be described in detail with reference to the accompanying drawings. Further, in the following description of the present disclosure, a detailed explanation of known related functions or configurations may be omitted to avoid unnecessarily obscuring the subject matter of the present disclosure. In addition, terms to be described below may vary according to user's and operator's intentions, convention, or the like as terms defined by considering functions of the present disclosure. Therefore, the definition should be made according to the contents throughout this specification.

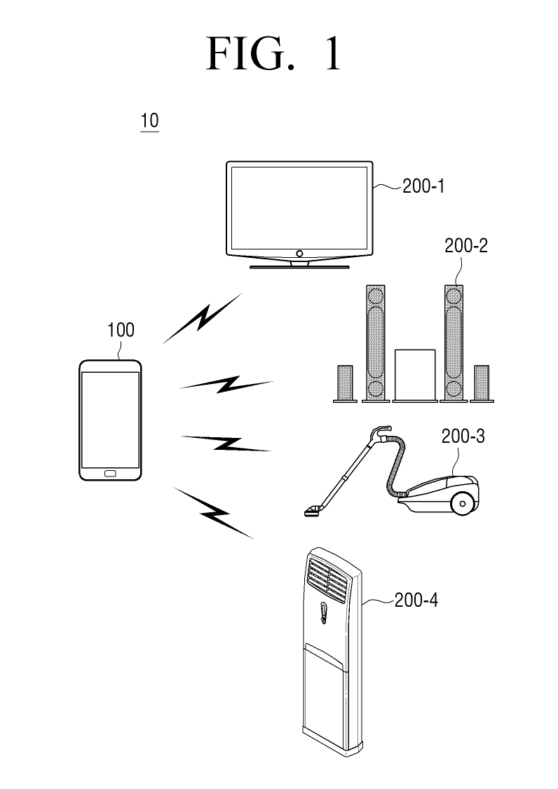

FIG. 1 is a diagram illustrating a home network system according to an example embodiment of the present disclosure. As illustrated in FIG. 1, a home network system 10 includes a communication terminal 100 and a plurality of electronic devices 200-1, 200-2, 200-3, and 200-4. In this case, the communication terminal 100 may be a smart phone as illustrated in FIG. 1, but this is just an example and communication terminal 100 may be implemented by various types of devices such as a mobile phone, a tablet PC, and a wired telephone including a call function (including a voice call function and a video call function). Further, the plurality of electronic devices 200-1, 200-2, 200-3, and 200-4 may be a DTV 200-1, an audio device 200-2, a cleaner 200-3, and an air conditioner 200-4 as illustrated in FIG. 1, but these are just examples and the electronic devices may be implemented by various types of electronic devices such as a PC, a set-top box, a dishwasher, and a washing machine. Meanwhile, the communication terminal 100 and the plurality of electronic devices 200-1, 200-2, 200-3, and 200-4 which are included in the home network system 10 communicate with each other in a wired or wireless manner.

The communication terminal 100 may perform a call function with another external communication terminal (not illustrated). Particularly, when a call request is received from another communication terminal, the communication terminal 100 detects the sound level of audio outputted by the plurality of electronic devices 200-1, 200-2, 200-3, and 200-4 included in the home network system 10 by using a sound level detector.

When the sound level of audio outputted by the plurality of electronic devices 200-1, 200-2, 200-3, and 200-4 is greater than or equal to a predetermined threshold value (for example, 80 dB), the communication terminal 100 transmits a control command to reduce the sound level outputted by the electronic device 200 to the predetermined value to at least one of the plurality of electronic devices 200-1, 200-2, 200-3, and 200-4.

As an example embodiment of the present disclosure, when the sound level of audio outputted by the plurality of electronic devices 200-1, 200-2, 200-3, and 200-4 is greater than or equal to the predetermined threshold value, the communication terminal 100 determines a kind of electronic device outputting the sound level which is greater than or equal to the predetermined threshold value to establish communication with the determined electronic device and transmits the control command to the determined electronic device to reduce the sound level to a predetermined value when the communication with the determined electronic device is established. In this case, the communication terminal 100 may determine the kind of electronic device by using at least one of an output direction of the sound, a frequency pattern of the sound, and a kind of sound.

As another example embodiment of the present disclosure, when the sound level of audio outputted by the plurality of electronic devices 200-1, 200-2, 200-3, and 200-4 is greater than or equal to the predetermined threshold value, the communication terminal 100 may transmit the control command to reduce the sound level to the predetermined value to all external electronic devices which communicate with the communication terminal 100.

The electronic device(s) receiving the control command among the plurality of electronic devices 200-1, 200-2, 200-3, and 200-4 perform(s) an operation for reducing the sound level of audio outputted by the electronic device to the predetermined value according to the control command. For example, the DTV 200-1 and the audio device 200-2 reduce the outputted sound level of audio to the predetermined value, the cleaner 200-3 turns off the power in order to remove the audio (that is, noise generated during an cleaning operation), and the air conditioner 200-4 may reduce the strength of wind (air flow) or turn off the power in order to reduce the audio (that is, noise generated when the wind is generated).

In addition, when a call with another communication terminal ends, the communication terminal 100 may transmit “a control command to return to the sound level which was outputted before calling” to at least one of the plurality of electronic devices 200-1, 200-2, 200-3, and 200-4.

When the control command to return to the sound level which was outputted before calling is transmitted, the electronic device(s) which reduced the sound level among the plurality of electronic devices 200-1, 200-2, 200-3, and 200-4 perform(s) an operation for returning the sound level of audio to the sound level which was outputted before calling. For example, the DTV 200-1 and the audio device 200-2 return the sound level of the output audio to the state before calling, the cleaner 200-3 turns on the power again, and the air conditioner 200-4 may return to the strength of the wind (or air flow) before calling.

As described above, the user may make a call in a quieter environment without a separate operation by the home network system 10.

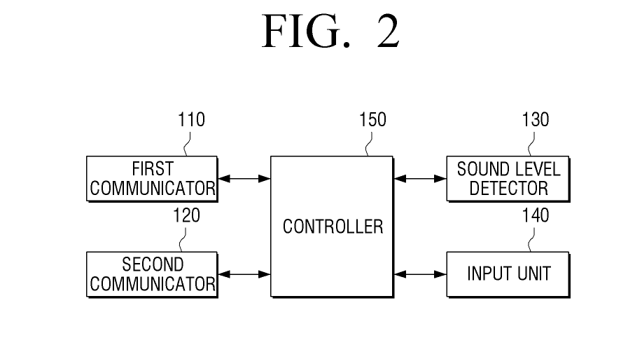

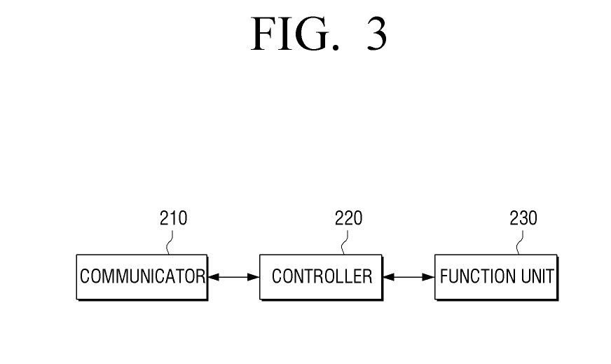

Hereinafter, the communication terminal 100 and the electronic device 200 will be described with reference to FIGS. 2 and 3.

FIG. 2 is a block diagram schematically illustrating a configuration of the communication terminal 100 according to the example embodiment of the present disclosure. As illustrated in FIG. 2, the communication terminal 100 includes a first communicator 110, a second communicator 120, a sound level detector 130, an input unit 140, and a controller 150.

The communication terminal 100 illustrated in FIG. 2 is configured to perform a calling function and a sound level control function of an external electronic device, and when other functions (for example, a video viewing function) are added, an additional component(s) other than the components illustrated in FIG. 2 may be added or the illustrated components may be modified to other components.

The first communicator 110 makes a call with another external communication terminal. In detail, the first communicator 110 is configured to perform a voice call with another external communication terminal by using a mobile communication network or to perform a voice call or a video call with another external communication terminal by using an IP network.

The second communicator 120 performs communication with the electronic devices 200 included in the home network system 10. Particularly, the second communicator 120 may transmit a control command to control the sound level of audio of the electronic devices 200 according to a control of the controller 150. Meanwhile, the second communicator 120 according to the example embodiment of the present disclosure may, for example, be implemented by a Wi-Fi module, but this is just an example, and the second communicator 120 may be implemented by various communication modules such as a Bluetooth module, a Zigbee module, and a WLAN module.

The sound level detector 130 is configured to detect the sound level of audio outputted by the external electronic device(s) 200. Particularly, the sound level detector 130 may be implemented by a sound level meter so as to convert and output noise generated in the home to sound pressure with a decibel (dB) unit corresponding to the noise. In this case, the sound level detector 130 may include multiple detectors positioned in a plurality of regions of an area external to the communication terminal 100 to detect an output direction of the audio.

Meanwhile, the sound level detector 130 may be activated only when a call request is received from another communication terminal.

The input unit 140 is configured to receive a user command(s) to control the communication terminal 100. Particularly, the input unit 140 may receive a user command to set a predetermined threshold value for use in reducing the sound level of audio outputted by the electronic device 200. Further, the input unit 140 may receive a user command to set a predetermined value for the sound reducing, which is included in the control command.

The controller 150 is configured to control an overall function of the communication terminal 100. Particularly, when the sound level outputted by electronic device(s) 200 detected through the sound level detector 130 is greater than or equal to the predetermined threshold value, the controller 150 controls the second communicator 120 to transmit the control command to the electronic device(s) 200 to reduce the sound level outputted by the electronic device(s) 200 to the predetermined value.

In detail, when the sound level outputted by electronic device(s) 200 detected through the sound level detector 130 is greater than or equal to the predetermined threshold value, the controller 150 may determine a kind of electronic device outputting the sound level which is greater than or equal to the predetermined threshold value and control the second communicator 120 to establish communication with the determined electronic device. In detail, the controller 150 may determine the kind of electronic device 200 by using at least one of an output direction of the sound outputted from the electronic device 200, a frequency pattern of the sound, and a kind of sound. For example, the controller 150 may determine a position from which the sound is outputted by determining the output direction of the sound to determine the kind of electronic device 200 disposed at the output position. Alternatively, the controller 150 may determine whether the sound is noise (for example, noise generated when the cleaner operates, noise generated when the air conditioner operates, and the like) by analyzing the frequency pattern of the sound to determine the kind of electronic device 200. Alternatively, the controller 150 may determine whether the kind of sound is music to determine the kind of electronic device 200. When the kind of electronic device is determined, the controller 150 may control the second communicator 120 to establish communication with the determined electronic device. Meanwhile, in the example embodiment of the present disclosure, it is described that the controller 150 establishes communication with the electronic device 200 after determining the kind of electronic device 200, but this is just an example, and the communication with the electronic device 200 may be established before determining the kind of electronic device 200.

When the communication with the electronic device 200 determined through the second communicator 120 is established, the controller 150 may control the second communicator 120 to transmit the control command to the determined electronic device to reduce the sound level of audio outputted by the electronic device to the predetermined value or less. In detail, when the determined electronic device is the DTV 200-1 or the audio device 200-2, the controller 150 may control the second communicator 120 to transmit a control command to the DTV 200-1 or the audio device 200-2 to reduce the sound level of audio outputted by the DTV 200-1 or the audio device 200-2 to the predetermined value or less (for example, 30 dB or mute). When the determined electronic device is the cleaner 200-3, the controller 150 may control the second communicator 120 to transmit a control command to the cleaner 200-3 to turn off the power so as to remove the audio (for example, noise generated during the cleaning operation) outputted by the cleaner 200-3. When the determined electronic device is the air conditioner 200-4, the controller 150 may control the second communicator 120 to transmit a control command to the air conditioner 200-4 to turn off the power or reduce the wind (air flow) strength to the predetermined value or less so as to remove the audio (for example, noise generated when the wind is generated) outputted by the air conditioner 200-4.

Meanwhile, according to another example embodiment of the present disclosure, when the sound level outputted by the electronic device(s) 200 is greater than or equal to the predetermined threshold value, the controller 150 may control the second communicator 120 to transmit a control command to all external electronic devices to which the communication with the communication terminal 100 is connected to reduce the sound level of audio outputted by the electronic device(s) 200. For example, when the electronic device 200 to which the communication with the communication terminal 100 is connected is the DTV 200-1 and the cleaner 200-3, the controller 150 may control the second communicator 120 to transmit a control command to the DTV 200-1 and the cleaner 200-3 to which the communicator is connected to reduce the sound level of audio.

When a call with another communication terminal ends, the controller 150 may control the second communicator 120 to transmit a control command to the electronic device(s) 200 for returning to a sound level which was outputted before the call. In detail, the controller 150 may control the second communicator 120 to transmit a control command to the DTV 200-1 and the audio device 200-2 to return to a sound level of audio before the call. Alternatively, the controller 150 may control the second communicator 120 to transmit a control command to the cleaner 200-3 to turn on the power again. Alternatively, the controller 150 may control the second communicator 120 to transmit a control command to the air conditioner 200-4 to return to the strength of the wind (air flow) before the call.

FIG. 3 is a diagram schematically illustrating a configuration of the electronic device 200 according to the example embodiment of the present disclosure. The electronic device 200 includes a communicator 210, a controller 220, and a function unit 230. Meanwhile, in the present disclosure, components other than the components illustrated in FIG. 3 may be added according to a kind of electronic device 200.

The communicator 210 performs communication with the external communication terminal 100. Particularly, the communicator 210 may receive a control command to control the sound level of audio outputted by the electronic device 200. Meanwhile, the communicator 210 according to the example embodiment of the present disclosure may be implemented by a Wi-Fi module, but this is just an example, and communicator 210 may be implemented by various communication modules such as a Bluetooth module, a Zigbee module, and a WLAN module.

The function unit 230 performs the function of the electronic device 200 according to a kind of electronic device 200. In detail, when the electronic device 200 is the DTV 200-1, the function unit 230 performs a function of reproducing video contents. When the electronic device 200 is the audio device 200-2, the function unit 230 performs a function of reproducing music contents or audio contents. When the electronic device 200 is the cleaner 200-3, the function unit 230 performs a function of sucking foreign substances (for example, dust, waste, and the like) in order to perform the cleaning. When the electronic device 200 is the air conditioner 200-4, the function unit 230 performs a function of generating the wind (air flow).

The controller 220 controls an overall function of the electronic device 200. Particularly, the controller 220 may control an audio outputted by the electronic device 200 according to a control command received from the communication terminal 100 through the communicator 210.

In detail, when a control command to reduce the sound level of audio outputted by the electronic device 200 is received from the communication terminal 100 through the communicator 210, the controller 220 may control the function unit 230 according to the control command. For example, when the electronic device 200 is the DTV 200-1 or the audio device 200-2, the controller 220 may control the function unit 230 according to the control command to reduce the sound level of audio outputted by the DTV 200-1 or the audio device 200-2 to the predetermined value or less (for example, 30 dB or mute). When the electronic device is the cleaner 200-3, the controller 220 may turn off the power of the function unit 230 so as to remove the audio (for example, noise generated during the cleaning operation) outputted by the cleaner 200-3. When the electronic device is the air conditioner 200-4, the controller 220 may control the function unit 230 to turn off the power of the function unit 230 or reduce the wind strength (air flow) to the predetermined value or less so as to remove the audio (for example, noise generated when the wind is generated) outputted by the air conditioner 200-4.

Further, in the case where the communicator 100 ends a call, when the control command to return to the sound level of audio outputted by the electronic device 200 before the call is received from the communication terminal 100 through the communicator 210, the controller 220 may control the function unit 230 according to the control command. For example, when the electronic device 200 is the DTV 200-1 or the audio device 200-2, the controller 220 may control the function unit 230 of the DTV 200-1 or the audio device 200-2 to return to the sound level of audio before the call. When the electronic device 200 is the cleaner 200-3, the controller 220 may turn on the power of the function unit 230 again. When the electronic device 200 is the air conditioner 200-4, the controller 220 may control the function unit 230 of the air conditioner 200-4 to return to the strength of the wind (air flow) before the call.

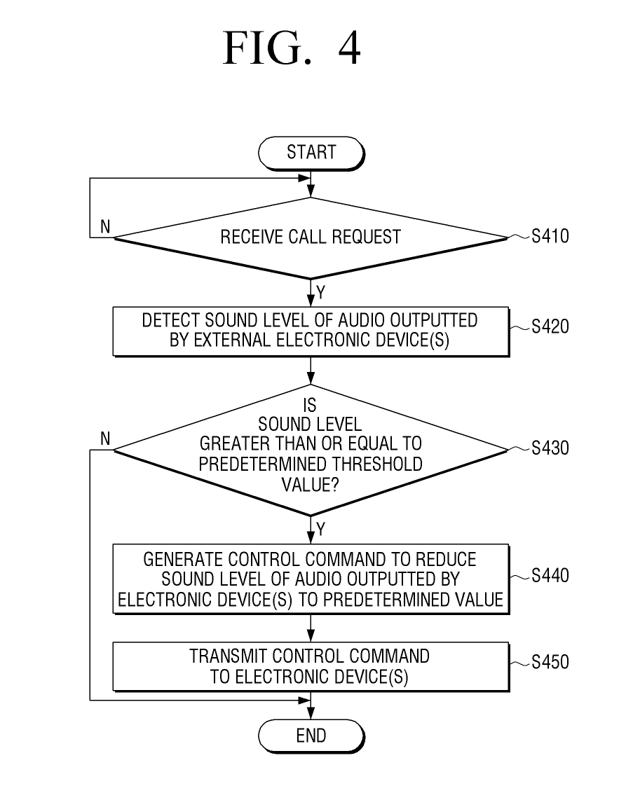

Hereinafter, a control method of the communication terminal 100 will be described with reference to FIG. 4.

First, the communication terminal 100 determines whether a call request is received from another communication terminal (S410). In this case, the call with another communication terminal may be a voice call, but this is just an example and the call may be a video call.

When the call request is received (S410-Y), the communication terminal 100 detects the sound level of audio outputted by the external electronic device(s) 200 (S420). In this case, the communication terminal 100 may detect the sound level outputted by the external electronic device(s) 200 by using a sound level meter. In particular, the sound level meter may be activated only when the call request is received.

In addition, the communication terminal 100 determines whether the detected sound level is greater than or equal to the predetermined threshold value (S430). In this case, the predetermined threshold value may be set by the user through the input unit 140.

When the detected sound level is greater than or equal to the predetermined threshold value (S430-Y), the communication terminal 100 generates the control command to reduce the sound level of audio outputted by the electronic device(s) 200 to the predetermined value (S440). In this case, the communication terminal 100 may generate different control commands according to a kind of electronic device 200. For example, when the electronic device 200 is the DTV 200-1 or the audio device 200-2, the communication terminal 100 may generate a control command to reduce the sound level of audio outputted by the DTV 200-1 or the audio device 200-2 to the predetermined value or less, and when the electronic device 200 is the cleaner 200-3, the communication terminal may generate a control command to turn off the power of the cleaner 200-3 in order to remove the audio (that is, noise) generated when the cleaner operates.

In addition, the communication terminal 100 transmits the generated control command to the electronic device(s) 200 (S450).

As described above, the user may make the call in a quieter environment without a separate operation by automatically removing noise of the electronic device(s) which may be generated when the communication terminal makes the call.

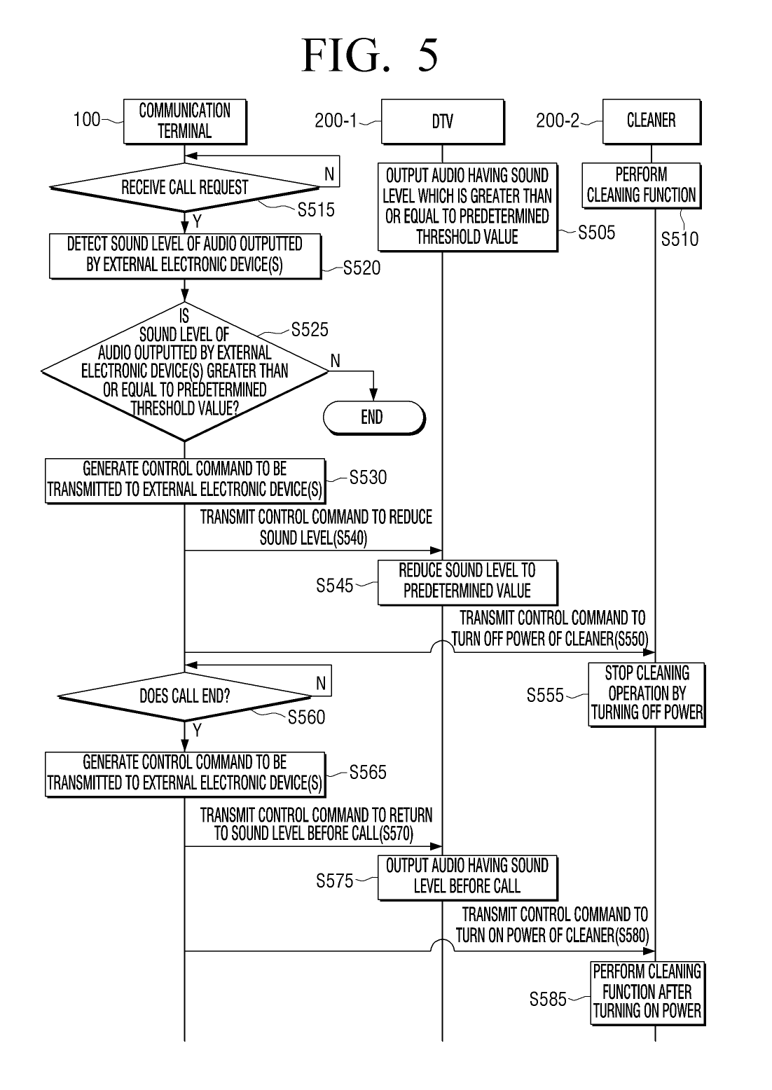

Hereinafter, a control method of the electronic device in the home network system will be described with reference to FIG. 5.

First, the DTV 200-1 outputs audio having a sound level which is greater than or equal to the predetermined threshold value (S505). In addition, the cleaner 200-3 performs the cleaning function by operating a compressor (S510).

Thereafter, the communication terminal 100 determines whether a call request is received from another communication terminal (S515).

When a call request is received from another communication terminal, the communication terminal 100 detects the sound level of audio outputted by the external electronic devices 200-1 and 200-3 (S520). In this case, the communication terminal 100 may detect the sound level of audio outputted by the external electronic device(s) by using a sound level meter.

In addition, the communication terminal 100 determines whether the sound level of audio outputted by the external electronic device(s) is greater than or equal to the predetermined threshold value (S525).

When the sound level is greater than or equal to the predetermined threshold value (S525-Y), the communication terminal 100 generates a control command to be transmitted to the external electronic devices 200-1 and 200-3 (S530). In this case, the communication terminal 100 may generate a control command to reduce the sound level so as to be transmitted to the DTV 200-1 and generate a control command to turn off the power so as to be transmitted to the cleaner 200-3.

The communication terminal 100 transmits the control command to reduce the sound level to the DTV 200-1 (S540). When the control command to reduce the sound level is received, the DTV 200-1 reduces the sound level to the predetermined value (S545).

In addition, the communication terminal 100 transmits the control command to turn off the power of the cleaner 200-3 to the cleaner 200-3 (S550). When the control command to turn off the power of the cleaner 200-3 is received, the cleaner 200-3 turns off the power to stop the cleaning operation (S555).

Thereafter, the communication terminal 100 determines whether the call with the other communication terminal ends (S560).

When the call ends (S560-Y), the communication terminal 100 generates a control command to be transmitted to the external electronic devices 200-1 and 200-3 (S565). In this case, the communication terminal 100 may generate a control command to return to the sound level before the call so as to be transmitted to the DTV 200-1 and generate a control command to turn on the power so as to be transmitted to the cleaner 200-3.

The communication terminal 100 transmits the control command to return to the sound level before the call to the DTV 200-1 (S570). When the control command to return to the sound level before the call is received, the DTV 200-1 outputs audio having the sound level before the call (S575).

In addition, the communication terminal 100 transmits the control command to turn on the power of the cleaner 200-3 to the cleaner 200-3 (S580). When the control command to turn on the power of the cleaner 200-3 is received, the cleaner 200-3 turns on the power to perform the cleaning function (S585).

As described above, while the user performs the call function by using the communication terminal 100, the sound level of the electronic device(s) 200 is reduced, and after the call ends, the sound level returns again to the sound level before the call, and thus, the user may perform the call function in a quiet environment without any input.

The control method of the communication terminal according to the aforementioned various example embodiments is implemented by a program to be provided to the communication device.

In detail, a non-transitory computer readable medium which stores the program for detecting the sound level of audio outputted by an external electronic device when a call request is received from another communication terminal; and transmitting to the electronic device a control command to reduce the sound level of audio outputted by the electronic device to the predetermined value when the sound level outputted by the electronic device is greater than or equal to the predetermined threshold value may be provided.

The non-transitory readable medium means a medium which at least semi-permanently stores the data and is readable by the apparatus. In detail, various aforementioned applications or programs may be stored and provided in the non-transitory readable medium such as a CD, a DVD, a hard disk, a blu-ray disk, a USB, a memory card, and a ROM.

Meanwhile, the detailed example embodiments have been described in the detailed description of the present disclosure, but various modifications can be made without departing from the scope of the present disclosure. Therefore, the scope of the present disclosure should not be limited to the example embodiments and should be defined by the appended claims and equivalents to the appended claims.

1. A control method for a communication terminal, the method comprising:
detecting a sound level of audio outputted by an external electronic device when a call request is received from another communication terminal; and
transmitting a control command to the electronic device to reduce a sound level of audio outputted by the electronic device to a predetermined value when the sound level outputted by the electronic device is greater than or equal to a predetermined threshold value.

2. The control method as claimed in claim 1, further comprising:
determining a kind of electronic device outputting the sound level which is greater than or equal to the predetermined threshold value when the sound level outputted by the electronic device is greater than or equal to the predetermined threshold value;
establishing communication with the determined electronic device; and
transmitting the control command to the determined electronic device when the communication with the determined electronic device is established.

3. The control method as claimed in claim 2, wherein, in the determining, the kind of electronic device is determined by using at least one of an output direction of the sound outputted from the electronic device, a frequency pattern of the sound, and a kind of sound.

4. The control method as claimed in claim 1, wherein
the transmitting includes transmitting the control command to multiple external electronic devices with which communication with the communication terminal is established when the sound level outputted by the multiple electronic devices is greater than or equal to the predetermined threshold value.

5. The control method as claimed in claim 1, wherein the detecting includes activating a sound level meter for detecting the sound level outputted from the electronic device when the call request is received from the other communication terminal.

6. The control method as claimed in claim 1, further comprising:
when the call with the other communication terminal ends, transmitting to the electronic device a control command for returning the electronic device to return to the sound level outputted before the call.

7. The control method as claimed in claim 1, wherein the predetermined threshold value and the predetermined value included in the control command are user-configurable.

8. The control method as claimed in claim 1, wherein the external electronic device includes one or more of a digital television TV, an audio device, a person computer (PC), an air conditioner, and a cleaner.

9. The control method as claimed in claim 8, wherein, when the external electronic device is the cleaner, a control command for turning off power of the cleaner is transmitted to the cleaner.

10. A communication terminal comprising:
first communication circuitry configured to receive a call request from another communication terminal;
second communication circuitry configured to perform communication with an external electronic device;
a sound level detector configured to detect a sound level of audio outputted by the external electronic device; and
controller circuitry configured to control the second communication circuitry to transmit a control command to the electronic device to reduce a sound level of audio outputted by the electronic device to a predetermined value when the sound level of audio outputted by the electronic device detected through the sound level detector is greater than or equal to a predetermined threshold value.

11. The communication terminal as claimed in claim 10, wherein the controller circuitry is configured to determine a kind of electronic device outputting the sound level of audio which is greater than or equal to the predetermined threshold value when the sound level of audio outputted by the electronic device detected through the sound level detector is greater than or equal to the predetermined threshold value, controls the second communication circuitry to establish communication with the determined electronic device, and controls the second communication circuitry to transmit the control command to the determined electronic device when the communication with the determined electronic device is established.

12. The communication terminal as claimed in claim 11, wherein the controller circuitry is configured to determine the kind of electronic device by using at least one of an output direction of sound outputted from the electronic device, a frequency pattern of the sound, and a kind of sound.

13. The communication terminal as claimed in claim 10, wherein the controller circuitry is configured to control the second communication circuitry to transmit the control command to multiple external electronic devices with which communication with the communication terminal is established when the sound level of audio outputted by the multiple electronic devices is greater than or equal to the predetermined threshold value.

14. The communication terminal as claimed in claim 10, wherein the sound level detector is activated only when the call request is received from the other communication terminal.

15. The communication terminal as claimed in claim 10, wherein the controller circuitry is configured to, when the call with the other communication terminal ends, control the second communication circuitry to transmit a control command to the electronic device for returning the electronic device to the sound level outputted before the call.
